(19) United States
(12) Patent Application Publication
(10) Pub. No.: US 2013/0266099 A1
(43) Pub. Date: Oct. 10, 2013

(54) MULTIPLE SIGNAL TIMING CONTROL FOR JOINT DETECTION INTERFERENCE CANCELLATION

(71) Applicant: Russell C. McKown, Richardson, TX (US)

(72) Inventor: Russell C. McKown, Richardson, TX (US)

(73) Assignee: ADVANCED RECEIVER TECHNOLOGIES, LLC, Dallas, TX (US)

(21) Appl. No.: 13/439,263

(22) Filed: Apr. 4, 2012

(51) Int. Cl. H04B 1/10

(52) U.S. Cl. 375/346

(57) ABSTRACT

A module and method for a joint detection interference cancellation receiver with the multiple signal timing control and interference cancellation timing control. The invention provides a means of performing interference cancellation for signals that are asynchronous with respect to each other while enabling signal synchronous processing of the individual signals. The present invention can be utilized with wireless signals that posses a signal format defining a fixed timing interval and a frame structure.

### CROSS-REFERENCE TO RELATED APPLICATIONS

The present patent application is related to U.S. Provisional Patent Application 60/628,248 filed on Nov. 16, 2004, entitled Chip-Level No-Decision Feedback Equalizer For CDMA Wireless Systems, U.S. patent application Ser. No. 11/280,858 filed on Nov. 16, 2005, entitled Chip-Level No-Decision Feedback Equalizer For CDMA Wireless Systems, and U.S. patent application Ser. 10/796,596 filed on Mar. 9, 2004, entitled Methods and Apparatus For Single Burst Equalization of Single Carrier Signals In Broadband Wireless Access Systems, now issued U.S. Pat. No. 7,388,910, issued on Jun. 17, 2008, the contents of each of which are incorporated by reference herein.

### BACKGROUND OF INVENTION

In current telecommunication systems, digital information of interest is typically communicated from a transmitter at one location to a receiver at another location by first forming a sequence of symbols based on the digital information and then using the symbol sequence to modulate a single carrier signal or a multiple carrier signal. At the receiver, the carrier signal is removed and the resultant, so called, ‘baseband’ signal is processed to recover first the symbols and then the digital information of interest. In general, signals used to communicate digital information from a transmitter to a receiver can be referred to as digital communication signals. Although the details of the mapping of the digital information onto the symbols vary from one application to another as do the details of the signal modulation, it is standard practice in the design of digital communication signals to use a fixed symbol rate (or a well defined set of fixed symbol rates) such that the individual symbols are used to modulate the signal for a fixed interval of time. The inverse of this individual symbol time interval is referred to as the symbol rate.

An example of such a telecommunication signal is the third generation (3G) Wideband Code Division Multiple Access (WCDMA) signal specified by the Third Generation Partnership Project (3GPP) standards organization. For the WCDMA signal, and code division multiple access signals in general, the fundamental timing interval is the chip rate whereas the symbol rates are well defined multiples of the chip rate.

Symbol (chip) timing recovery refers to the process in the communications signal receiver that estimates the time when the information and/or energy associated with individual symbols (chips) arrives in the received communications signal. The transmitter typically clocks the symbol (chip) interval based on a crystal oscillator and, in order to be accurate, the timing recovery process at the receiver must be capable of dynamically tracking changes in the fundamental timing interval that are due to variations in the transmitter's crystal oscillator frequency. The time when the information and/or energy associated with individual symbols (chips) arrives in the received communications signal also varies due to changes in the relative position of the transmitter and the receiver. For example, if the receiver is in a cellular phone which is in an automobile that is moving relative to a fixed base station transmitter at a cell tower, then the radio signal propagation distance and time-of-travel are changing and hence, the signal arrival time is changing.

The problem of multiple signal interference occurs when the signal of interest is received in the presence of other signals that interfere with the reception of the signal of interest. For example, downlink intercell signal interference occurs when the signals from non-desired cellular base stations interfere with the signal from a desired serving base station. Downlink intercell signal interference commonly occurs when multiple base stations are on the same network and frequency. This form of multiple signal interference is a technical problem that plagues the wireless industry by limiting the useable network capacity and causing poor user experiences in the form of dropped calls and unacceptable delays during data transfer, for example, in smartphone data applications.

Joint detection interference cancellation is a known method of mitigating the problem of multiple signal interference. For example, consider an N-signal joint detection interference cancellation receiver, where N-1 interfering signals and one signal of interest are jointly detected. Such a receiver detects or estimates the signal information in the N signals. The joint detections are processed to provide estimates of the received N-1 interfering signals and these estimates are subtracted from a delayed version of the received signal. Ideally, the subtraction of the interfering signal estimates cancels the actual interfering signals and the signal of interest can be received as if the interfering signals did not exist. It is generally accepted that joint detection interference cancellation receivers have the potential to provide a high performance solution to the problem of multiple signal interference. It is also generally accepted that such receivers are difficult to implement in practice.

A problem encountered in implementing a joint detection interference cancellation receiver is to provide a means of accurately subtracting the interfering signal estimates from the received signal. This subtraction is complicated by the fact that timings of the multiple signals are not stationary with respect to each other. For example, in the case of downlink intercell interference, not only are the crystals of the individual base stations varying independently of each other, the motion of the subscriber and the associated mobile phone receiver is such that the propagation distance from some base stations may be decreasing while the propagation distance from others may be increasing. These effects result in the signals being asynchronous; there is a non-stationary precession of the timing of the individual signals relative to each other.

Although the multiple signals are asynchronous relative to each other, signal synchronous processing is generally required to detect the information content of the individual signals. Typically, the signal synchronous processing is performed on signal subframes that are defined by the signal's time division multiplex format. For example, for the WCDMA signal, the signal synchronous processing can be performed on a symbol-aligned subframe consisting of 256 chips. The detected signal information content is used in a joint detection interference cancellation receiver to generate estimates of the individual received signals.

A joint detection interference cancellation receiver requires signal synchronous processing of individual signals and must accurately subtract estimates of the asynchronous interfering signals from the received signal. As such, what is needed is a robust means of control of both multiple signal-synchronous timings and the asynchronous timings required for interference cancellation.

### SUMMARY OF INVENTION

The invention provides a system (or module) and method of a multiple signal timing control and interference cancellation timing control for a joint detection interference cancellation receiver. The invention provides a means of performing interference cancellation for signals that are asynchronous with respect to each other while enabling signal synchronous processing of the individual signals. The present invention can be utilized with wireless signals that posses a signal format defining a fixed timing interval and a frame structure.

### BRIEF DESCRIPTION OF THE DRAWINGS

FIG. 1 of the present invention depicts a block diagram of an example implementation of certain processes performed by an implementation of a joint detection interference cancellation receiver with the multiple signal timing control and interference cancellation timing control invention;

FIG. 2 of the present invention depicts an example implementation of the timing relationship between the samples of the received signal at the input and output of Sample Selection and Interpolation Signal n module;

FIG. 3 depicts a block diagram of an example implementation of known component modules that together comprise one of the Received Signal n Estimation modules of the present invention;

FIG. 4a and FIG. 4b illustrate examples of the timing relationship between the samples at the input of the Interpolation and Subtraction module of the present invention;

FIG. 5 shows a flow chart diagram of certain processes performed by an implementation of the Multiple Signal Timing Recovery module of the present invention;

FIG. 6 shows a flow chart diagram of certain processes performed by an implementation of the Multiple Signal Timing Recovery module and the Determine Signal N Sample Rate Fs module, of the present invention;

FIG. 7 shows a flow chart diagram of certain processes performed by an implementation of the Interpolation and Subtraction module, of the present invention.

### DETAILED DESCRIPTION OF THE INVENTION

The present invention provides a system (or module) and method of a multiple signal timing control and interference cancellation timing control for a joint detection interference cancellation receiver. The invention provides a means of performing interference cancellation for signals that are asynchronous with respect to each other while enabling signal synchronous processing of the individual signals. The present invention can be utilized with wireless signals that posses a signal format defining a fixed timing interval and a frame structure. Examples of such signals include the WCDMA and LTE signals specified by the Third Generation Partnership Project (3GPP) and the WiFi (802.11) and WiMax (802.16) signals specified by the Institute of Electrical and Electronic Engineers (IEEE).

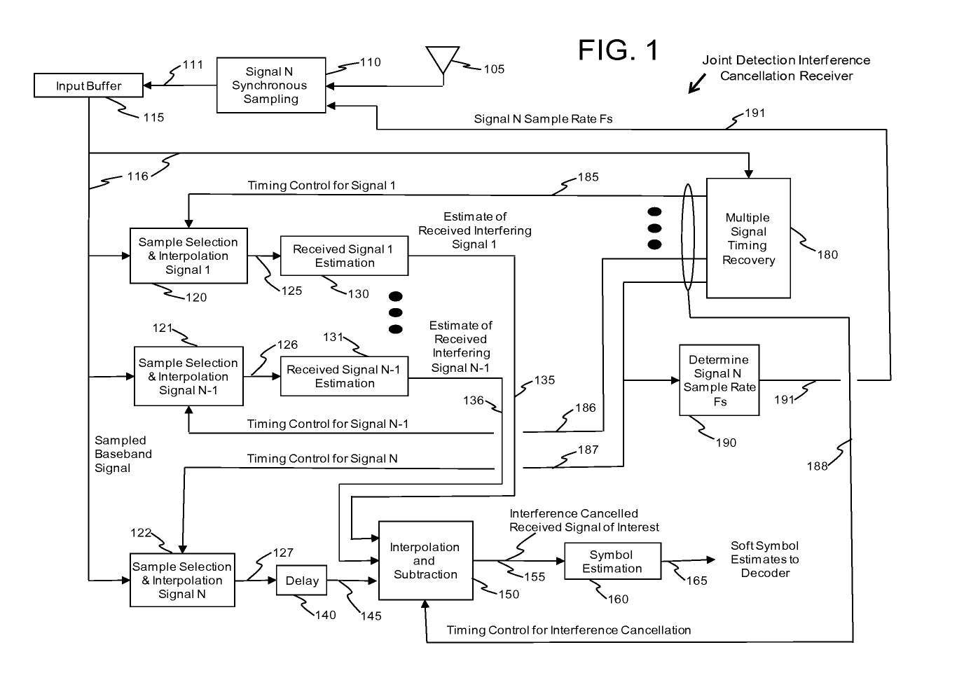

FIG. 1 shows a block diagram of certain processes performed by an implementation of a joint detection interference cancellation receiver with the multiple signal timing control and interference cancellation timing control invention. The notational convention is maintained of jointly detecting signals n=1 to N where Signal N is the signal of interest and signals n=1 to N-1 are the interfering signals to be cancelled.

In the process configuration of FIG. 1, multiple radio frequency signals are received with one or more antennas, radio frequency front-ends and down conversions 105 which input to a Signal N Synchronous Sampling module 110 that creates a sampled digital in-phase and quadrature baseband signal 111 with the N_buffer most recent of these samples being stored in the Input Buffer 115. To allow sample rate adjustment, the Signal N Sample Rate Fs 191 is input to the Signal N Synchronous Sampling module 110 and is set by the Determine Signal N Sample Rate Fs module 190.

Initially the Signal N Sample Rate Fs is a nominally synchronous sample rate defined here as a sample rate that is an integer multiple of the signal's specified fixed timing interval. For example, for WCDMA signals a nominally synchronous sample rate that provides 2 samples per chip interval is 7.68×10⁶ samples per second=2×chip rate (3GPP specifies the WCDMA chip rate to be 3.84×10⁶ chips per second). As is known, synchronous samples can be determined by an interpolation of samples that were determined at a nominally-synchronous sample rate. The implementation of the Signal N Synchronous Sampling module 110 can be either a digital interpolator that performs a sample rate conversion by interpolating nominally-synchronous sampled data based on Signal N Sample Rate Fs 191 or it can be an analog-to-digital sampler and converter with the sample intervals determined by the Signal N Sample Rate Fs 191. In either case, the sample rate of the output of the Signal N Synchronous Sampling module 110 is determined by the Signal N Sample Rate Fs 191.

The N Sample Selection and Interpolation modules 120 to 122 input the sampled received signal 116 from the Input Buffer 115 and output signal-synchronous, received signal samples 125 to 127 given, respectively, N timing control parameter sets, Timing Control for Signal n, 1≦n≦N, 185 to 187, from the Multiple Signal Timing Recovery module 180. Received Signal n Estimation modules 130 and 131 input signal-synchronous received signal samples, 125 and 126, and output estimates 135 and 136 of the received n^{th} interfering signal, for n=1 to N-1, to the Interpolation and Subtraction module 150.

In the invention, the outputs of the Sample Selection and Interpolation Signal n modules 120 to 122, the Received Signal n Estimation modules 130 to 131, and the Interpolation and Subtraction module 150 are each aligned with a signal processing subframe of the respective signal n. The term signal processing subframe is used here to indicate the selection of a relatively small frame structure of the signal that is convenient for block, e.g., sample vector or sample matrix, signal processing at the receiver level. For example, for the WCDMA signal, such a signal processing subframe is conveniently defined as the samples and data associated with a 256-chip, symbol-aligned signal segment, i.e., a 256-chip signal segment that contains all 256 chips of a WCDMA symbol that has a spread factor of 256. In the example embodiment of the invention in FIG. 1, the Sample and Interpolation Signal n modules 120 to 122, the Received Signal n Estimation modules 130 to 131, the Interpolation and Subtraction module 150, the Multiple Signal Timing Recovery module 180 and the Determine Signal N Sample Rate Fs module 190, all operate on a subframe-block signal processing basis in which the outputs are associated with a block of subframe-aligned signal data.

Continuing to reference FIG. 1, the output 127 of Sample Selection and Interpolation Signal N module 122 is sampled received signal that is subframe-aligned and signal-synchronous relative to the N^{th} signal, which is of interest. This sampled received signal 127 is delayed in module 140 by a delay that is equivalent to the sum of one signal processing subframe and the processing delay associated with the N-1 Received Signal n Estimation modules 130 to 131 which estimate the N-1 interfering signals.

The Interpolation and Subtraction module 150 inputs, from 140, the delayed received signal 145 which is subframe-aligned and synchronous to the signal N of interest and also inputs 135 and 136, the estimates of the received N-1 interfering signals, i.e., Estimate of Interfering Received Signal n, for n=1 to N-1. The Interpolation and Subtraction module 150 subtracts interpolated samples of the interfering signals from the delayed received signal 145 based on the Timing Control for Interference Cancellation 188. In the invention, the Timing Control for Interference Cancellation 188 is defined as the aggregate of the N Timing Control for Signal n parameter sets, i.e., for n=1 to N. The Interpolation and Subtraction module 150 outputs the Interference Cancelled Received Signal of Interest 155.

The Symbol Estimation module 160 in FIG. 1 inputs the Interference Cancelled Received Signal of Interest 155, estimates Soft Symbol Estimates 165 using known methods and outputs the estimates to a decoder processing function, for example a Turbo decoder, which follows the joint detection interference cancellation receiver diagrammed in FIG. 1. Examples of known methods for the Symbol Estimation module 160 include the Rake receiver and the equalizer receiver as described by J. G. Proakis in chapter 14 of Digital Communications, McGraw-Hill 2000.

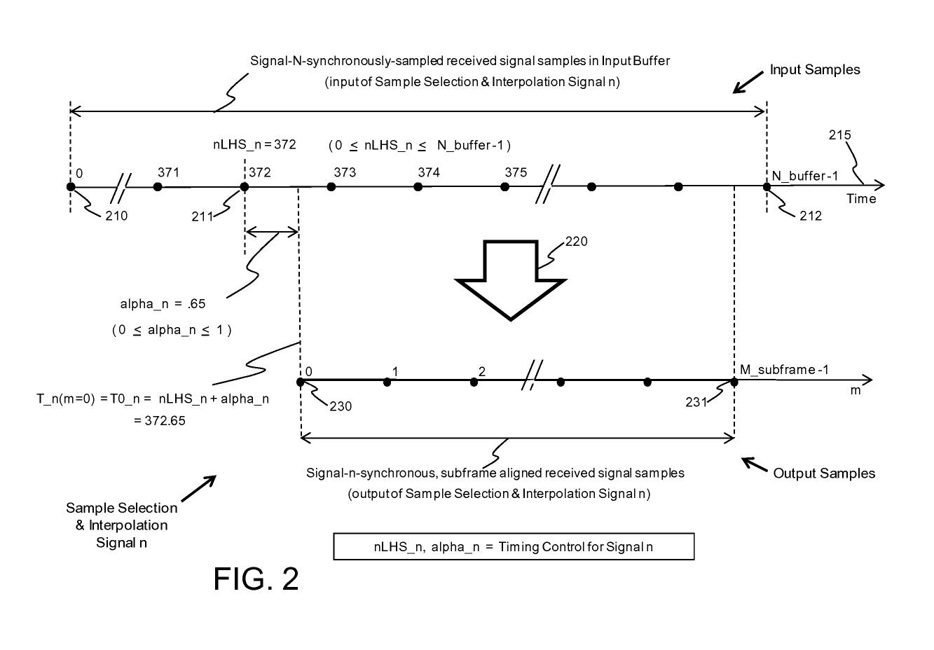

FIG. 2 illustrates an example of the timing relationship between the samples of the received signal at the input and output of Sample Selection and Interpolation Signal n module where 1≦n≦N, i.e., one of modules 120 to 122 in FIG. 1. The samples available at the input, in Input Buffer 115, are illustrated at the top of FIG. 2 and are numbered between 0 and N_buffer-1 corresponding to the dots between 210 and 212. The Sample Selection and Interpolation Signal n module also inputs the Timing Control for Signal n, i.e., one of 185 to 187 in FIG. 1, which in an example embodiment consists of the parameters nLHS_n and alpha_n. nLHS_n is an integer sample time (or equivalently a base-point index parameter) and alpha_n is a fractional sample time (or equivalently a fractional interval parameter), where the unit of time is the sample interval equal to 1/Fs where Fs is the Signal N Sample Rate Fs 189 that was applied in module 110 of FIG. 1. The base-point index and fractional interval parameters are described by Floyd M. Gardner, Interpolation in Digital Modems—Part I: Fundamentals, in IEEE Transactions on Communications, vol. 41, no. 3, March 1993. As illustrated in FIG. 2, the sum of these parameters, T0_n=nLHS_n+alpha_n, defines the interpolation time of the first sample 230 in the subframe-aligned, signal-synchronous output sample vector 230 to 231. In the example illustrated, the first output sample 230 is associated with an interpolation time of T0_n=372.65=372+0.65 (1/Fs units of sample time).

Note that in the example implementation of the invention, sample time is everywhere defined with respect to the sample time scale of the Input Buffer 115. For example, as illustrated in FIG. 2, the first output sample 230 from the Sample Selection and Interpolation Signal n module has an output sample index of m=0 and a sample time of 372.65 where the sample time scale 215 is defined at the Input Buffer 115.

Letting Fs_n denote the true synchronous sample rate for signal n, consider the effects of a true-synchronous-to-actual sample rate error defined as Fs_n-Fs where Fs is the Signal N Sample Rate Fs 191 that was applied by the Signal N Synchronous Sampling module 110 to provide the N_buffer samples in the Input Buffer 115. The true synchronous sample rate, Fs_n is an integer multiple of the true chip rate of signal n. If the length of the output sample vector, M_subframe, is small compared to sample lengths that are significant in regard to the Fs_n-Fs sample rate error, then the requested interpolation time T_n(m) of the m^{th} sample in the output sample vector can be defined simply as T_n(m)=T0_n+m for m=0 to M_subframe-1. Conversely, this assumes that the true-synchronous-to-actual sample rate error, Fs_n-Fs, results in an insignificant timing error in a time interval corresponding to M_subframe samples. For example, consider WCDMA signals with a Signal N sampling rate of Fs=7.68×10⁶ samples per second and M_subframe=512 samples given a signal processing subframe of length 256 chips. If the fractional sample rate error, (Fs_n-Fs)/Fs, is +/−50 parts per million and it is known that the requested interpolation time, T(0)=T0_n, for the first, m=0, output sample is accurate. It follows that using T(M_subframe-1)=T0_n+511 to define the requested interpolation time of the last, m=M_subframe-1, output sample results in a maximum requested interpolation sample time error of only +/−0.0256 sample interval (1/Fs). Such a small error in the requested interpolation sample time is insignificant and can be ignored.

The more general case of large M_subframe and/or large true-synchronous-to-Signal-N-synchronous sample rate error is readily included in the present invention by using a more complicated specification of the requested interpolation times for the samples in the output of the Sample Selection and Interpolation Signal n modules, 120 to 122 in FIG. 1. For example, the requested interpolation time for the m^{th} output sample can be specified as T_n(m)=T0_n+f(m,V) where f is represents a function to be calculated or a lookup table and V represents the additional parameters. In the general case, the Multiple Signal Timing and Interference Cancellation Control module 180 in FIG. 1 can augment the base-point index, nLHS_n, and the fractional interval, alpha_n, parameters in the Timing Control for Signal n message with additional parameters or data to allow a sufficiently accurate specification of the requested interpolation times for the samples in the output signal vector of the Sample Selection and Interpolation Signal n module.

Continuing to reference FIG. 2, an example illustration of the processing in the Sample Selection and Interpolation Signal n modules, 120 to 122 in FIG. 1, it is noted that the nLHS_n base-point index parameter identifies the received sample 211 occurring at time nLHS_n=372 in the Input Buffer 115 as the nearest sample to the left of the time of start of a signal n processing subframe. Together, the base-point index, nLHS_n, and the fractional interval, alpha_n, identify the requested interpolation times for the M_subframe output samples as

T_{—}n(m)=nLHS_{—}n+alpha_{—}n+m

for 0≦m≦M subframe-1 where m identifies the m^{th} sample in the subframe-aligned, signal-synchronous received-signal sample vector that is output from the Sample Selection and Interpolation Signal n module. The large arrow 220 in FIG. 2 represents the interpolation process that the Sample Selection and Interpolation Signal n module uses to determine the interpolated subframe-aligned, signal-synchronous, received-signal output sample vector, 230 to 231, given the above requested interpolation times T_n(m) and the input baseband signal samples, 210 to 212, in the Input Buffer 115. Several methods of interpolation that can be used for this interpolation process are well known, for example as described by Floyd M. Gardner, Interpolation in Digital Modems—Part II: Implementation and Performance, in IEEE Transactions on Communications, vol. 41, no. 6, June 1993.

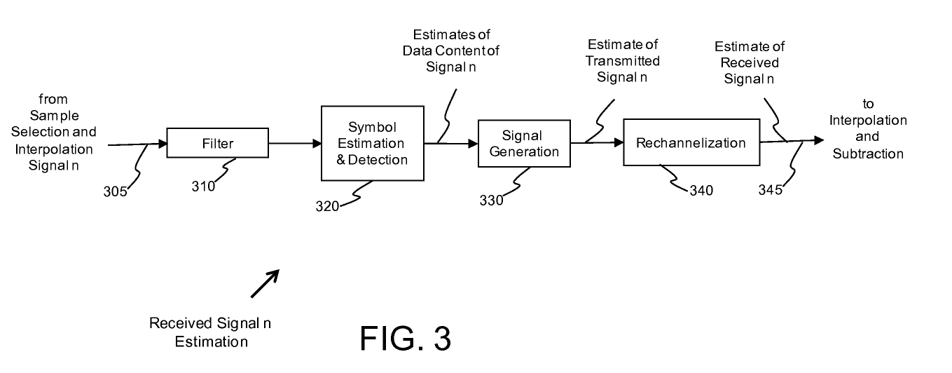

FIG. 3 provides an example implementation of known component modules that together comprise one of the Received Signal n Estimation modules, 130 to 131, in FIG. 1. Filter 310 inputs the subframe-aligned, signal-synchronous sampled received signal 305 from a Sample Selection and Interpolation Signal n module, 120 to 121, in FIG. 1 and filters the signal to compensate for the time dispersion effects of the propagation channel. For example, for CDMA or other time domain signals, Filter 310 can be a minimum mean squared error (MMSE) equalizer filter or a conjugate matched filter, including the Rake implementation. Continuing the example of CDMA signals, the Symbol Estimation and Detection module 320, can consist of a code despreader followed by a non-linear symbol decision device or slicer that outputs hard symbol decisions. This output of the Symbol Estimation and Detection module 320 is an estimate of the data content of signal n. The Signal Generation module 330 in a WCDMA example consists of a spread operation that multiplies, i.e., modulates, code waveforms by the hard symbol decisions, a modulated spread code summing device and a complex multiplication that applies the scrambling code of that is known to be associated with signal n. The output of the Signal Generation module 330 is a signal waveform representing an estimate of the transmitted signal n. Finally, the Rechannelization module 340 convolves the estimate of the transmitted signal n with an estimate of the channel impulse response for signal n to provide an estimate of the received signal n 345 that is output to the Interpolation and Subtraction module 150 in FIG. 1.

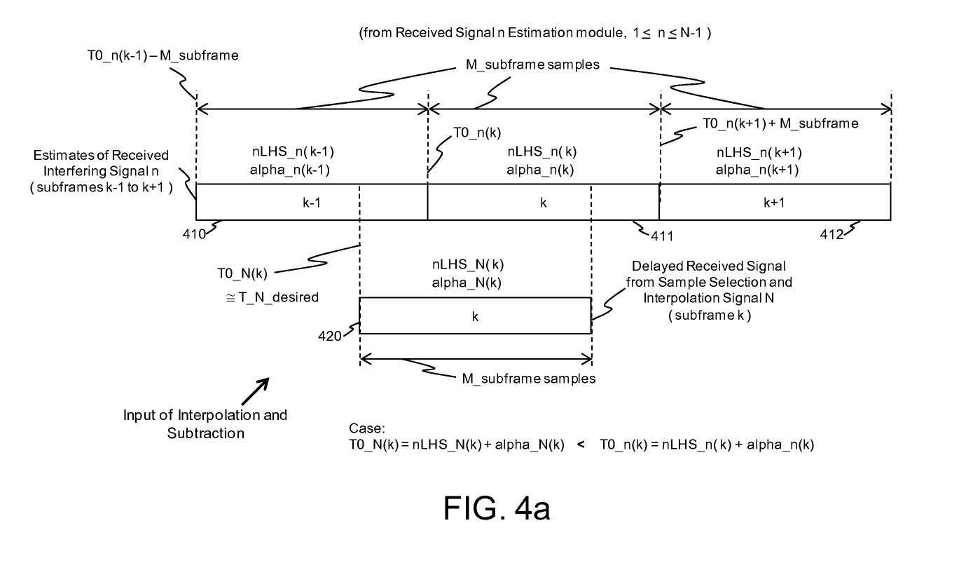

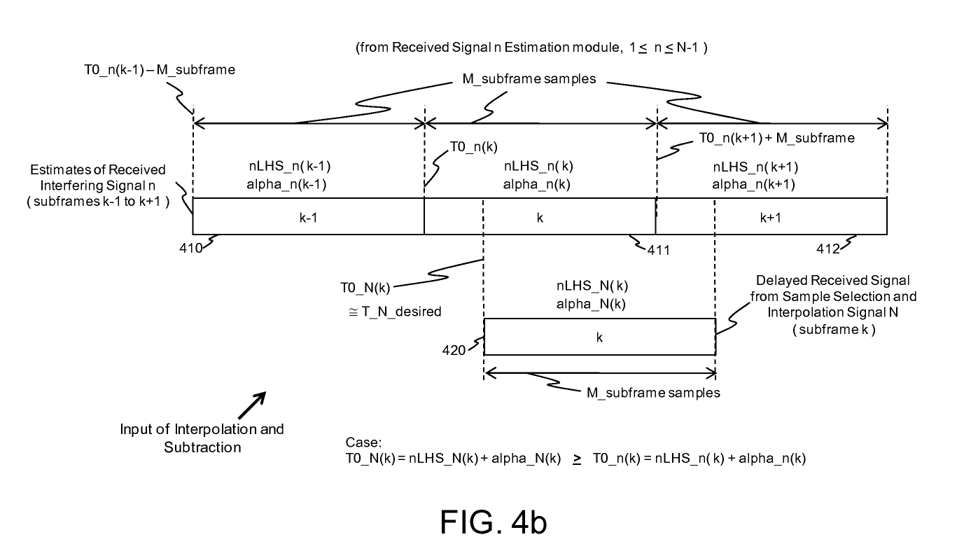

FIGS. 4a and 4b illustrate examples of the timing relationship between the samples at the input of the Interpolation and Subtraction module, identified as 150 in FIG. 1. The index k is a receiver subframe processing cycle index. The times T0_n(k) and T0_N(k) refer to the sample times that are associated with the 1^{st} sample of the k^{th} subframe for interfering signal n where 1≦n≦N-1 and the signal N of interest, respectively. In the example embodiment of the invention, these sample times refer to the sample time scale 215 in FIG. 2 which is defined at the Input Buffer 115.

The top of FIGS. 4a and 4b illustrate estimates of received interfering signal n for signal processing cycles k−1, k and k+1, 410 to 412, that are buffered and available as input to the Interpolation and Subtraction module from one of the Received Signal n Estimation modules, 130 to 131 in FIG. 1. Below these three subframes, FIGS. 4a and 4b illustrate the k^{th} subframe 420 of the received signal that has been subframe-aligned and synchronously-sampled for signal of N and input to the Interpolation and Subtraction module from the Delay module, identified as 140 in FIG. 1. The Delay module 140 results in the k^{th} processing cycle of the received signal that has been subframe-aligned and synchronously-sampled for signal of N being available to the Interpolation and Subtraction module at the same time as the k+1 processing cycle of the estimates of received interfering signal n.

As indicated in FIGS. 4a and 4b, T0_N(k), the sample time of the start of the k^{th} subframe 420 of signal N, is kept near a fixed desired sample time, T_N_desired, i.e.,

T0_{—}N(k)≅T_{—}N_desired

as a result of the combined action the Multiple Signal Timing Recovery module 180 for signal N, the Determine Signal Sample Rate Fs module 191 and the Signal N Synchronous Sampling 110 of this invention, as described further below. FIG. 4a shows the case where the start of the k^{th} subframe of the signal of interest N precedes the start of the k^{th} subframe of the interfering signal n. This is the case when

T0_{—}N(k)=nLHS_{—}N(k)+alpha_{—}N(k)<T0_{—}n(k)=nLHS_{—}n(k)+alpha_{—}n(k)

FIG. 4b shows the case where the start of the k^{th} subframe of the signal of interest N lags the start of the k^{th} subframe of the interfering signal n. This is the case when

T0_{—}N(k)=nLHS_{—}N(k)+alpha_{—}N(k)>T0_{—}n(k)=nLHS_{—}n(k)+alpha_{—}n(k).

For completeness, FIG. 4b also includes the rare case of equivalent start times for the k^{th} subframe of the signal of interest N and the k^{th} subframe of the interfering signal n, which is the case when T0_N(k)=T0_n(k).

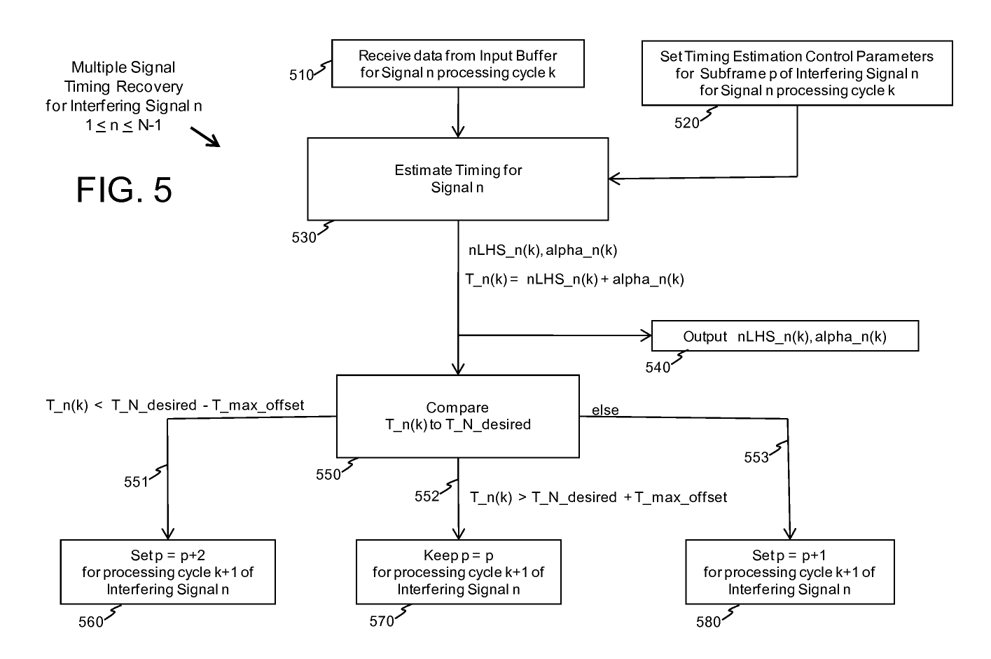

FIG. 5 shows a flow chart diagram of certain processes performed by an implementation of the Multiple Signal Timing Recovery module, 180 in FIG. 1, of the present invention. These processes determine the timing parameters of the interfering signal n, for 1≦n≦N-1, and set the timing estimation control parameters associated with interfering signal n in a manner that compensates for the precession of the interfering signal relative to signal N, which is of interest. The processes in FIG. 5 can be executed every receiver subframe processing cycle, which is indexed by k, and reside in the Multiple Signal Timing Recovery module, 180. The data in the Input Buffer 115 in FIG. 1 is received 510 and the timing estimation control parameters are set for subframe p of interfering signal n 520. These data and control parameters are input to Estimate Timing for Signal n 530 which determines the base-point index, nLHS_n(k), and the fractional interval, alpha_n(k), for signal n and receiver processing cycle k. The determined nLHS_n(k), and alpha_n(k) are output 540 from the Multiple Signal Timing Recovery module, 180, as part or all of the parameter set identified as Timing Control for Signal n, 185 to 186 in FIG. 1.

The Estimate Timing for Signal n 530 uses known, signal class-and-format dependent methods to determine the start time of the a signal subframe, which as discussed above, defines the base-point index, nLHS_n, and the fractional interval, alpha_n of the Timing Control for Signal n 185 to 187 for 1≦n≦N. For example, for WCDMA signals, the Estimate Timing for Signal n 530 can use known methods to estimate the channel impulse response (CIR) using the sampled baseband data and the scramble code for signal n. Known methods to estimate the CIR include, for example, the method described by S. F. A. Shah and A. U. H. Sheikh in Downlink Channel Estimation for IMT-DS, 12^{th} IEEE Int. Symp. on Personal, Indoor and Mobile Radio Communications, vol. 2, pp. E-137 to 141, September 2001. Given the CIR estimate, the time-of-peak of the absolute value of the CIR, T_peak, directly determines a base-point index, nLHS_n, and a fractional interval, alpha_n, as

T_peak=(nLHS_{—}n+alpha_{—}n)/Fs

such that nLHS_n=NILE(T_peak*Fs) and alpha_n=(T_peak−(nLHS_n/Fs))*Fs where NILE is the nearest-integer-less-than-or-equal-to operation.

In general, as indicated 520 in FIG. 5, the parameter p selects the timing estimation control parameters for signal n in the k^{th} processing cycle of the receiver. For the example of a WCDMA receiver having a 256 chip signal processing subframe, the parameter p is an index that shifts the scramble code used to estimate the CIR by 256 chips. In equation notation this can be written as

sc_used(m)=sc(m+p*256)

where sc_used(m) is the scramble code used for the m^{th} chip processed from the Input Buffer 115 for estimating the CIR and sc is the known scramble code for signal n. It is implied that the argument of sc is modulus the length of the scramble code.

Referring to FIG. 5, the Compare T0_n(k) to T_N_desired process 550 recognizes one of three regions for T0_n(k) relative to T_N_desired as follows:

1) T0_n(k)<T_N_desired−T_max_offset. This condition occurs when the time of the start of the k^{th} subframe of interfering signal n is too early relative to the desired time of start of the subframe for signal N of interest. To correct this condition, the timing estimation control parameters for signal n in the next, k+1, receiver processing cycle are advanced an extra subframe by the Set p=p+2 block 560.

2) T0_n(k)>T_N_desired+T_max_offset. This condition occurs when the start of the k^{th} subframe of interfering signal n is too late relative to the desired time of start of the subframe for signal N of interest. To correct this condition, the timing estimation control parameters for signal n in the next, k+1, receiver processing cycle are not advanced by the Keep p=p block 570.

3) T_N_desired−T_max_offset≦T0_n(k)≦T_N_desired+T_max_offset. This is the ‘else’ condition and occurs when the start of the k^{th} subframe of interfering signal n is close enough to the desired time of start of the subframe for signal N of interest. This condition requires no correction, the timing estimation control parameters for signal n in the next, k+1, receiver processing cycle are advanced to the next subframe by the Set p=p+1 block 580.

In an example implementation the acceptable timing offset parameter, T_max_offset, can be set to 0.75*M_subframe to allow adequate timing. The above adjustment of the parameter p which selects the timing estimation control parameters for the p^{th} subframe of interfering signal n allows the receiver to track the asynchronous interfering signal n and to insure the input of the Interpolation and Subtraction module 150 maintains the timing relationships illustrated in FIGS. 4a and 4b.

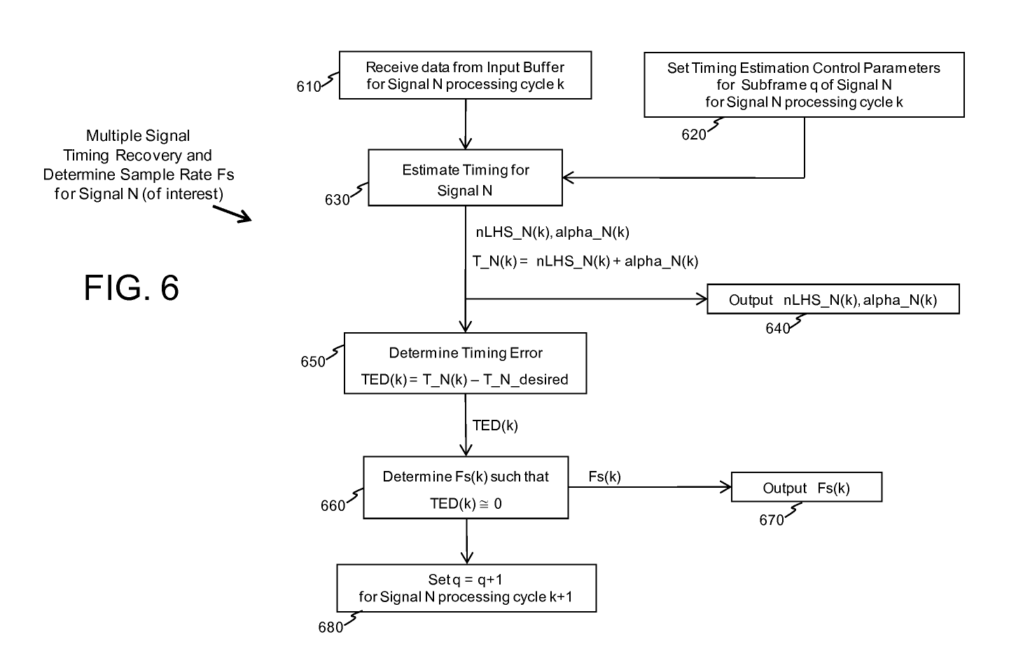

FIG. 6 shows a flow chart diagram of certain processes performed by an implementation of the Multiple Signal Timing Recovery module 180 and the Determine Signal N Sample Rate Fs module 190 in FIG. 1, of the present invention. These processes determine the timing parameters of the signal N, which is of interest, and determine the sample rate Fs that is synchronous with signal N. The processes in FIG. 6 can be executed every receiver subframe processing cycle, which is indexed by k. The data in the Input Buffer 115 in FIG. 1 is received 610 and the timing estimation control parameters are set for subframe q of signal N 620. These data and control parameters are input to Estimate Timing for Signal N 630 which determines the base-point index, nLHS_N(k), and the fractional interval, alpha_N(k), for signal N and receiver processing cycle k. The determined nLHS_N(k), and alpha_N(k) are output 640 from the Multiple Signal Timing Recovery module, 180, as part or all of the parameter set identified as Timing Control for Signal N, 187 in FIG. 1.

As shown in FIG. 6, the Determine Timing Error process 650 inputs T0_N(k)=nLHS_N(k)+alpha_N(k), the estimated time of the 1^{st} sample of the q^{th} subframe of signal N, which is of interest, in the received signal. This process 650 determines a timing error detector, TED(k), for the kth receiver processing cycle as the difference between T0_N(k) and the fixed desired time, T_N_desired, for the start of the signal N processing subframe, i.e.,

TED(k)=T0_{—}N(k)−T_{—}N_desired.

The process 660 determines Fs(k) such that TED(k)≅0 as the sequence k advances. This is accomplished using known methods to adjust sample rate Fs(k) based on the timing error detector, TED(k), for example, those methods described in Chapter 7 of U. Mengali and A. N. D'Andrea, Synchronization Techniques for Digital Receivers, Plenum Press 1997. The resulting sample rate Fs(k) is output 670. Referring to FIG. 1, this Fs(k) is Signal N Sample Rate Fs 191 from the Determine Signal N Sample Rate Fs module 190, that is input to the Signal N Synchronous Sampling 110. Finally, the parameter q is incremented q=q+1 680. This is in preparation for setting the timing estimation control parameters for subframe q+1 of signal N 620 when the processes shown in FIG. 6 are executed during the upcoming receiver processing cycle k+1.

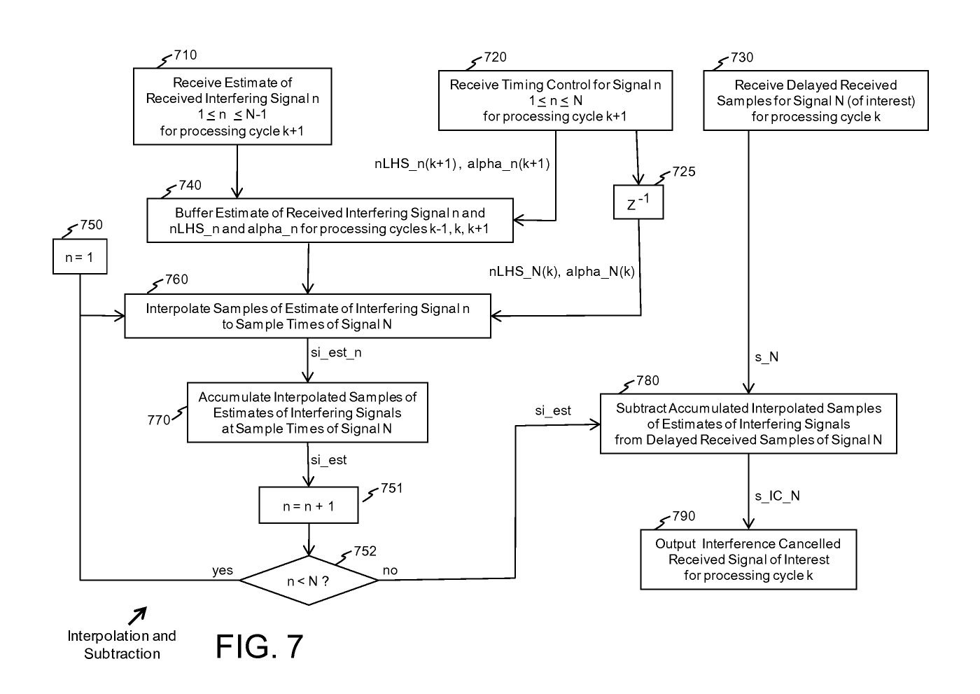

FIG. 7 shows a flow chart diagram of certain processes performed by an implementation of the Interpolation and Subtraction module 150 in FIG. 1, of the present invention. The Interpolation and Subtraction module receives:
1) the N-1 Estimates of the Received Interfering Signal n for 1≦n≦N-1 and for processing cycle k+1, 710, from the Received Signal n Estimation modules, 130 to 131, in FIG. 1;
2) the Timing Control for Signal n for 1≦n≦N and for processing cycle k+1, 720, from the Multiple Signal Timing Recover module, 180, in FIG. 1; and
3) the delayed received samples for signal N, which is of interest, 730, from the Delay module, 140, in FIG. 1.

The Estimate of the Received Interfering Signal n and the Timing Control for Signal n for each n, 1≦n≦N-1, are buffered 740 for processing cycles k−1, k and k+1; as illustrated in FIGS. 4a and 4b. The process control elements 750, 751 and 752 result in the interpolation process 760 and the interpolate accumulation process 770 being executed for n=1 to N-1. The interpolation process 760 inputs Timing Control for Signal N which is delayed 725 by one processing cycle and interpolates samples from the 3 subframe buffer of the Estimate of Interfering Signal n to the sample times of Signal N.

In the example implementation and as discussed above, the interpolation process 760 considers the sample time of the m^{th} sample in the k^{th} processing cycle of the Delayed Received Samples for Signal N to be defined as

T_{—}N(m)=nLHS_{—}N(k)+alpha_{—}N(k)+m

for m=0 to M subframe-1. For each T_N(m), the interpolation process 760 determines the samples in the 3 subframe buffer, illustrated in FIGS. 4a and 4b, that have sample times within a specified interpolation range of the T_N(m), for example, T_N(m)+2/Fs, and uses these samples and their sample times to form an interpolated sample of the Estimate of Interfering Signal n at the time T_N(m). Consistent with the illustration in FIGS. 4a and 4b, the sample time, T_n(s), of the s^{th} sample in the 3 subframe/processing cycle buffer containing Estimates of Received Interfering Signal n can be defined as

T_{—}n(s)=nLHS_{—}n(k−1)+alpha_{—}n(k−1)+s−M_subframe,

for 0≦s≦M_subframe-1;

T_{—}n(s)=nLHS_{—}n(k)+alpha_{—}n(k)+s−M_subframe,

for M_subframe≦s≦2*M_subframe-1; and

T_{—}n(s)=nLHS_{—}n(k+1)+alpha_{—}n(k+1)+s−M_subframe,

for 2*M subframe≦s≦3*M_subframe-1. Several methods of interpolation that can be used for the interpolation process 760 are well known, for example as described by Floyd M. Gardner, Interpolation in Digital Modems—Part II: Implementation and Performance, in IEEE Transactions on Communications, vol. 41, no. 6, June 1993.

Referring to FIG. 7, the interpolate accumulation process 770 accumulates the outputs of the interpolation process 760 at each of the M subframe sample times of the desired Signal N. For example, consider the case of N=3 such that the joint detection interference cancellation receiver of FIG. 1 is performing interference cancellation on signals 1 and 2 with signal 3 being the signal interest. If si_est_1(m) and si_est_2(m), for 0≦m≦M_subframe-1, are the samples from the interpolation process 760 for n=1 and 2, respectively, then the output of the interpolate accumulation process 770 can be written as si_est(m)=si_est_1(m)+si_est_2(m), for 0≦m≦M_subframe-1.

The interference cancellation is performed by process 780 in FIG. 7 that is given the name Subtract the Accumulated Interpolated Samples of Estimates of Interfering Signals from Delayed Received Samples of Signal N. For example, if s_N(m), 0≦m≦M_subframe-1, represent the samples of the Delayed Received Samples for Signal N for processing cycle k, then process 780 determines the Interference Cancelled Received Signal of Interest, s_IC_N(m), as

s_{—}IC_{—}N(m)=s_{—}N(m)−si_{—}est(m)

for 0≦m≦M_subframe-1. The interference cancelled received signal of interest, s_IC_N, is output 790 to the Symbol Estimation module 160 in FIG. 1 as described above.

What is claimed is:

1. A method of processing an interfering signal during a processing cycle, the method comprising:
receiving the interfering signal from an input buffer;
generating at least one timing estimation control parameter for a first subframe corresponding to the interfering signal received;
estimating timing information corresponding to the received interfering signal based on the at least one timing estimation control parameter; and
providing the timing information as feedback to a receiver to remove the interfering signal from a desired signal.

2. The method of claim 1, wherein estimating timing information comprises determining a start time of the first subframe.

3. The method of claim 1, wherein estimating timing information comprises estimating a channel impulse response (CIR) by using sampled baseband data associated with the interfering signal and a scramble code associated with the interfering signal.

4. The method of claim 3, further comprising:
comparing the estimated timing information to a desired start time of a subsequent subframe of the desired signal; and
determining whether to modify the at least one timing estimation control parameter for a subsequent processing cycle of a next subframe.

5. The method of claim 4, wherein determining whether to modify the at least one timing estimation control parameter for the subsequent processing cycle of a next subframe further comprises setting the at least one timing estimation control parameter to at least one of a same value or a greater value.

6. The method of claim 5, wherein the at least one timing estimation control parameter is kept to the same value if the start time of the subframe is greater than a sum of the desired start time of the subsequent subframe of the desired signal and a predefined timing offset value.

7. The method of claim 5, wherein the at least one timing estimation control parameter is incremented to a greater value if the start time of the subframe is less than a difference of the desired start time of the subsequent subframe of the desired signal and a predefined timing offset value.

8. An apparatus configured to process an interfering signal during a processing cycle, the apparatus comprising:
a receiver configured to receive the interfering signal from an input buffer; and
a processor configured to
generate at least one timing estimation control parameter for a first subframe corresponding to the interfering signal received,
estimate timing information corresponding to the received interfering signal based on the at least one timing estimation control parameter, and
provide the timing information as feedback to a receiver to remove the interfering signal from a desired signal.

9. The apparatus of claim 8, wherein the processor estimates timing information by determining a start time of the first subframe.

10. The apparatus of claim 8, wherein the processor estimates timing information by estimating a channel impulse response (CIR) by using sampled baseband data associated with the interfering signal and a scramble code associated with the interfering signal.

11. The apparatus of claim 10, wherein the processor is further configured to
compare the estimated timing information to a desired start time of a subsequent subframe of the desired signal, and
determine whether to modify the at least one timing estimation control parameter for a subsequent processing cycle of a next subframe.

12. The apparatus of claim 11, wherein to determine whether to modify the at least one timing estimation control parameter for the subsequent processing cycle of a next subframe further comprises setting the at least one timing estimation control parameter to at least one of a same value or a greater value.

13. The apparatus of claim 12, wherein the at least one timing estimation control parameter is kept to the same value if the start time of the subframe is greater than a sum of the desired start time of the subsequent subframe of the desired signal and a predefined timing offset value.

14. The apparatus of claim 12, wherein the at least one timing estimation control parameter is incremented to a greater value if the start time of the subframe is less than a difference of the desired start time of the subsequent subframe of the desired signal and a predefined timing offset value.

15. A non-transitory computer readable storage medium configured to store instructions that when executed cause a processor to perform processing an interfering signal during a processing cycle, the processor being further configured to perform:
receiving the interfering signal from an input buffer;
generating at least one timing estimation control parameter for a first subframe corresponding to the interfering signal received;
estimating timing information corresponding to the received interfering signal based on the at least one timing estimation control parameter; and
providing the timing information as feedback to a receiver to remove the interfering signal from a desired signal.

16. The non-transitory computer readable storage medium of claim 15, wherein estimating timing information comprises determining a start time of the first subframe.

17. The non-transitory computer readable storage medium of claim 15, wherein estimating timing information comprises estimating a channel impulse response (CIR) by using sampled baseband data associated with the interfering signal and a scramble code associated with the interfering signal.

18. The non-transitory computer readable storage medium of claim 17, wherein the processor is further configured to perform:
comparing the estimated timing information to a desired start time of a subsequent subframe of the desired signal; and
determining whether to modify the at least one timing estimation control parameter for a subsequent processing cycle of a next subframe.

19. The non-transitory computer readable storage medium of claim 18, wherein determining whether to modify the at least one timing estimation control parameter for the subsequent processing cycle of a next subframe further comprises setting the at least one timing estimation control parameter to at least one of a same value or a greater value.

20. The non-transitory computer readable storage medium of claim 19, wherein the at least one timing estimation control parameter is kept to the same value if the start time of the subframe is greater than a sum of the desired start time of the subsequent subframe of the desired signal and a predefined timing offset value.
